(19) United States
(12) Patent Application Publication
(10) Pub. No.: US 2024/0345542 A1
(43) Pub. Date: Oct. 17, 2024

(54) Anchor Escapement

(71) Applicant: Damasko Präzisionstechnik GmbH & Co. KG, Regensburg (DE)

(72) Inventor: Christoph Damasko, Regensburg (DE)

(21) Appl. No.: 18/616,561

(22) Filed: Mar. 26, 2024

(30) Foreign Application Priority Data
Mar. 27, 2023 (DE) 10 2023 107 683.3

(51) Int. Cl. G04B 15/14

(52) U.S. Cl. CPC G04B 15/14

(57) ABSTRACT

An anchor escapement (100) for a mechanical clockwork, in particular for pocket watches and wristwatches, having an anchor pivotable (110) around its bearing axis (111) and an escape wheel (120) rotatable around its axis of rotation (121), wherein the escape wheel (120) has successive escape wheel teeth (122) in the direction of rotation, which extend over a first component height (h) and the anchor (110) has anchor pallets (112) extending over a second component height (H) at its ends facing toward the escape wheel (120), which are arranged to mesh with the escape wheel teeth (122) of the escape wheel (120), so that when the anchor escapement (100) is in operation, the escape wheel teeth slide (122) in succession on the anchor pallets (112). The escape wheel teeth (122) slide on at least two different contact surfaces (a, b) of an anchor pallet (112) during operation.

The invention relates to an anchor escapement for a mechanical clockwork, in particular for pocket watches and wristwatches, having an anchor pivotable around its bearing axis and an escape wheel rotatable around its axis of rotation, wherein the escape wheel has successive escape wheel teeth in the direction of rotation, which extend over a first component height, and the anchor has anchor pallets extending over a second component height at its ends facing toward the escape wheel, which are arranged to mesh with the escape wheel teeth, so that when the anchor escapement is in operation, the escape wheel teeth slide in succession on the anchor pallets.

The invention also relates to a pocket watch or wristwatch having such an anchor escapement.

### BACKGROUND OF THE INVENTION

In a mechanical watch movement, the escapement establishes the connection between the gear train and the gear regulator. The gear train is connected to the drive of the clock and is used to transfer energy, for example to the clock hands, but also to the gear regulator. In pocket watches or wristwatches, a balance spring oscillation system is usually used as a gear regulator. Here, the balance wheel represents the oscillating body, which is usually designed as a rotatably mounted wheel, which is driven in the respective direction of rotation by the periodic swinging back and forth of the spring, usually a spiral spring. As an escapement, the anchor escapement consisting of an anchor and an escape wheel or “Swiss anchor escapement” has prevailed in pocket watches or wristwatches. The escape wheel engages in the gear train, the anchor is used to exchange momentum between the escape wheel or the gear train and the balance wheel. The functionality of a Swiss anchor escapement is well known and will therefore only be briefly explained below.

When the anchor escapement is in operation, the anchor is periodically pivoted back and forth around its bearing axis due to the oscillating movement of the balance wheel. The pivoting movement is limited in both directions by a limiting pin and thus sets the tempo, i.e., the rate of the clockwork. At the same time, the escape wheel is driven by the gear train in a direction of rotation around its axis of rotation. The escape wheel is preferably designed as a spur gear having escape wheel teeth pointing radially outward, which engage with the so-called anchor pallets of the anchor, by which the rotational movement of the escape wheel is inhibited. The anchor pallets usually consist of two ends of the anchor facing toward the escape wheel, which interact with the escape wheel teeth. Typically, the escape wheel and the anchor are designed having component heights that differ from one another, wherein the escape wheel or at least its escape wheel teeth extend along a first component height that runs essentially parallel to the axis of rotation and the anchor or at least its anchor pallets extend along a second component height that runs essentially parallel to the bearing axis.

During each oscillating movement of the anchor, one escape wheel tooth is released, i.e., the escapement is temporarily released, as a result of which the escape wheel advances one position in its direction of rotation and following the specified tempo or gear. When the escapement is in operation, the escape wheel teeth pointing radially outward slide one after the other on the escape wheel pallets in the direction of rotation of the escape wheel. The two components move against each other under pressure, which creates a frictional force that results in abrasion on the respective contact surfaces and thus in wear of the anchor escapement. This in turn has a detrimental effect on the gear accuracy.

Such an anchor escapement for a mechanical clockwork for pocket watches and wristwatches, which works according to the principle of the Swiss anchor escapement, is known from the prior art, namely EP 1 233 314 A1. In order to improve the accuracy of the movement, the interacting functional elements of the escapement, in particular the surfaces that interact with the teeth of the escape wheel, are provided with a DLC coating, a diamond-like carbon hard material coating. The disadvantage of such a hard material coating is that the run-in phase of the anchor escapement, during which microscopically small roughness of the component surfaces rubbing against one another is leveled out, is extended.

An anchor escapement is also known from EP 3 001 256 B1, in which the front flanks of the pallets of the anchor and the front flanks of the teeth of the escape wheel are provided with a hard material coating in order to reduce abrasion and thus wear. Producing the anchor and the escape wheel from silicon using a microtechnical dry etching process has also been proposed. Due to the production process, the flanks of the teeth of the escape wheel and the flanks of the pallets of the anchor never have an angle of 90° to the surface, a so-called non-verticality. The sloping component surfaces can be aligned either plane-parallel or opposite to one another. In order to reduce the contact surface between the teeth and the pallets of the anchor, the non-vertical flanks are to be aligned opposite to one another so that the contact surface between the components corresponds more to a contact line that is only approximately 2-4 μm wide. By choosing the height of the pallets to be less than the height of the teeth of the escape wheel, it is also to be ensured that the contact surface of the front flanks of the pallets is permanently defined during operation of the escapement. By minimizing the contact surfaces in this way, the run-in behavior between the components is to be improved and the run-in phase is to be shortened. However, it is disadvantageous that in every contact with a tooth of the escape wheel, the same contact surface of the pallets is engaged, which experiences n-fold wear during one complete revolution of the escape wheel, wherein “n” corresponds to the number of escape wheel teeth. Such increased wear then in turn has a disadvantageous effect on the gear accuracy.

It is therefore the object of the present invention to eliminate the disadvantages of the prior art and in particular to create an anchor escapement having improved wear behavior, improved run-in time, and improved gear accuracy.

### SUMMARY OF THE INVENTION

The object is achieved by an anchor escapement according to claim 1 and a pocket watch or wristwatch having such an anchor escapement according to claim 11.

An anchor escapement according to the invention of the type described in more detail at the beginning is characterized in that the escape wheel teeth and the ends of the anchor pallets facing toward the escape wheel are designed in such a way that the escape wheel teeth slide along at least two different contact surfaces of one or the same anchor pallet during operation of the anchor escapement.

According to the invention, in contrast to the prior art, it is thus provided that one anchor pallet has not a single, but at least two defined contact surfaces. The escape wheel teeth then do not always slide on the same contact surface, but on at least two different contact surfaces of the anchor pallet, that is, either along a first contact surface or along a second contact surface or also on further contact surfaces, for example along a third contact surface or along a fourth contact surface, etc. By designing the anchor pallets having multiple defined contact surfaces, the abrasion or wear caused by the escape wheel teeth can be reduced to a fraction. This allows the service life of the mechanical clockwork and its maintenance intervals to be extended many times over. The gear accuracy is thus improved, but at the same time the run-in time is also shortened due to the defined contact surfaces.

For example, according to an advantageous variant of the invention, the abrasion or wear caused on each of the contact surfaces can be halved by the escape wheel teeth sliding either along a first or along a second contact surface of the anchor pallets during operation of the anchor escapement. For this purpose, the ends of the anchor pallets facing toward the escape wheel can be designed having two defined contact surfaces, a first and a second.

Preferably, the first and second contact surfaces or further, different contact surfaces of the anchor pallets are formed at their ends facing toward the escape wheel and are arranged spaced apart from one another along the second component height. This has the advantage that overlaps of the contact surfaces are reliably avoidable, due to which each contact surface experiences the same wear or abrasion. For example, the width of a contact surface running in the direction of the second component height can be approximately 2-4 μm. The distance between the individual contact surfaces is then preferably in a range between 12 μm and 100 μm, depending on, among other things, the number of contact surfaces.

Furthermore, an advantageous exemplary embodiment provides that the escape wheel teeth are each designed having one or more contact edges, which slide along a respective contact surface of the anchor pallets during operation of the anchor escapement.

To define the at least two different contact surfaces on the anchor pallets, the escape wheel teeth can be designed having multiple, for example two, contact edges. During operation of the anchor escapement, either one or the other contact edge then slides on a respective, corresponding contact surface of an anchor pallet. Alternatively, each escape wheel tooth can be designed having only a single contact edge, which then slides on different contact surfaces of the anchor pallet during operation of the anchor escapement, i.e., either on a first contact surface or on a second contact surface or on further, for example a third or fourth contact surface, etc.

In a refinement of this exemplary embodiment, the one or more contact edges of the escape wheel teeth are formed by a bevel of the surface facing radially outward of an escape wheel tooth. In particular, the surfaces of the escape wheel facing radially outward then no longer run exactly parallel to the axis of rotation of the escape wheel, but enclose an angle therewith, for example, of 0.1° to 3.0°.

Preferably, such a bevel can be formed by a non-verticality of the surface facing radially outward of an escape wheel tooth, wherein the non-verticality is in a range between 0.1° and 3.0°. This means that the angle to the surface of the escape wheel tooth is not exactly 90°, but deviates from the right angle by 0.1° to 3.0°.

Likewise, according to a variant of the invention, it is advantageous that each escape wheel tooth is designed having exactly one contact edge and the contact edges of at least two escape wheel teeth are arranged at positions that deviate from one another along the first component height. For example, the escape wheel teeth that follow one another in the direction of rotation of the escape wheel can be designed alternately having a first contact edge, which is located at a first position relative to the first component height, and a second contact edge, which is located at a second position relative to the first component height. During operation of the anchor escapement, the escape wheel teeth slide successively on the anchor pallets, due to which alternately the first contact edge of an escape wheel tooth slides on a first contact surface and the second contact edge of the subsequent escape wheel tooth slides on another, a second contact surface of the same anchor pallet. Of course, such an embodiment can also be implemented for more than two, for example three or four contact edges, wherein then the contact edge of every third or fourth escape wheel tooth in particular is arranged in the same position.

In principle, it is conceivable to design the surfaces facing radially outward of the escape wheel teeth as roof-shaped, having a ridge or cylindrically curved outwards, in order to define the position of the contact edge in relation to the first component height.

According to an advantageous refinement of the variant of the invention, however, the position of the contact edge along the first component height of an escape wheel tooth is determined by a shoulder formed on the surface facing radially outward.

Such a shoulder can either be formed directly during the production of the escape wheel or also after completion of the escape wheel, for example, it can be incorporated later by applying a coating, by milling, or by an etching step.

Preferably, the anchor and/or the escape wheel are produced from a material containing silicon and/or at least the contact surfaces of the anchor pallets and/or the one or more contact edges of the escape wheel teeth are provided with a hard material coating, in particular a silicon, carbon or DLC coating. The layer thickness of such a coating is preferably in the range between 0.5 and 1.0 μm.

For example, the escape wheel or the anchor can be produced from silicon by a DRIE dry etching method (DRIE=Deep Reactive Ion Etch). It is conceivable to etch the escape wheel having the first component height, for example, approximately 100 μm to 150 μm, out of a wafer. In the area of the ends facing outward of the escape wheel teeth, for example, the etching process can be continued for every second escape wheel tooth, due to which a shoulder having a lesser height of, for example, 75 μm results. In this way, a contact edge can be created at the position of half the component height. Optionally, such contact edges or shoulders can also be created by a coating step by applying a hard material coating.

An alternative exemplary embodiment of the invention provides that the surfaces facing radially outward of each escape wheel tooth are formed along the first component height having a first contact edge and a second contact edge, wherein a bevel of the surface facing radially outward is implemented by the anchor being designed to be tiltable around its bearing axis and/or the escape wheel being designed to be tiltable around its axis of rotation by at least 0.3°, preferably at least 0.4°.

In this embodiment, it is therefore conceivable to design the surfaces of the escape wheel teeth facing radially outward and/or the surfaces of the anchor pallets facing the anchor vertically, i.e., at an angle of 90° in relation to their respective surface. Depending on the orientation of the escape wheel escapement, the escape wheel and/or the anchor tilt around their axis of rotation or bearing axis due to gravity, which results in an inclination or beveling of the surfaces of the two components facing toward one another. During operation of the anchor escapement, depending on the orientation, either the first or the second contact edge slides on the respective first or second contact surface. In order to define the two contact edges more clearly, it is also conceivable to design the surfaces of the escape wheel teeth facing radially outward to be directed inwards, in particular curved or concave inwards.

A change in alignment or change in position is caused during operation of the anchor escapement, in particular by wearing a wristwatch having the anchor escapement or by using a pocket watch having the anchor escapement. For example, moving the wrist changes the alignment of the anchor escapement of a wristwatch, which in turn causes the escape wheel and/or the anchor to tilt about their respective axes.

Finally, the object according to the invention stated at the outset is therefore also achieved by a pocket watch or wristwatch having an anchor escapement according to one of the embodiment variants described above.

### BRIEF DESCRIPTION OF THE SEVERAL VIEWS OF THE DRAWINGS

Further details, features, (sub) combinations of features, advantages, and effects on the basis of the invention result from the following description of preferred exemplary embodiments of the invention and the drawings. In the figures

FIG. 1 shows a perspective view of a first exemplary embodiment of the anchor escapement according to the invention,

FIG. 2 shows a sectional view of the anchor escapement from FIG. 1,

FIG. 3 shows a schematic side view of an escape wheel tooth and an anchor pallet in a first exemplary orientation,

FIG. 4 shows a schematic side view of the escape wheel tooth and the anchor pallet from FIG. 3 in a second exemplary orientation,

FIG. 5 shows a perspective view of an escape wheel according to a second exemplary embodiment of the anchor escapement according to the invention,

FIG. 6 shows a perspective detailed view of the escape wheel from FIG. 5,

FIG. 7 shows a schematic side view of an escape wheel tooth and an anchor pallet according to the second exemplary embodiment in a first position of the escape wheel,

FIG. 8 shows a schematic side view of an escape wheel tooth and an anchor pallet according to the second exemplary embodiment in a second position of the escape wheel, and

FIG. 9 shows a schematic side view of two escape wheel teeth and an anchor pallet according to the second exemplary embodiment.

The figures are merely exemplary in nature and only serve to understand the invention. The same elements are given the same reference numbers.

### DETAILED DESCRIPTION OF THE INVENTION

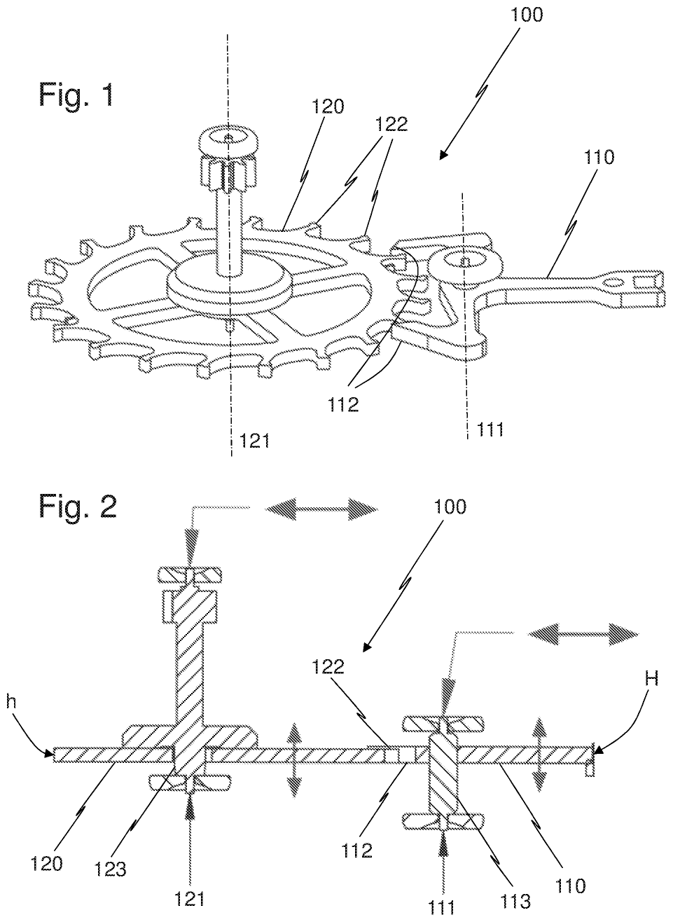

FIG. 1 shows a perspective view of a first exemplary embodiment of an anchor escapement 100 according to the invention, The anchor escapement 100 comprises an anchor 110 and an escape wheel 120 as essential components. The anchor 110 is pivotably mounted around a bearing axis 111 and the escape wheel 120 is rotatable around an axis of rotation 121. The escape wheel 120 is designed here as a spur gear and has successive escape wheel teeth 122 in the direction of rotation, which are directed radially outwards. The anchor 110 has an anchor pallet 112 at each of its two ends facing toward the escape wheel 120. The escape wheel teeth 122 and the anchor pallets 112 are aligned meshed so that when the anchor escapement 100 is in operation, the escape wheel teeth 122 slide successively on the anchor pallets 112 in the direction of rotation of the escape wheel 120.

A side sectional view of the anchor escapement 100 from FIG. 1 is shown in FIG. 2. It can be clearly seen that the surfaces of the escape wheel teeth 122 facing radially outward are designed having a first component height h running parallel to the axis of rotation 121 and the surfaces of the anchor pallets 112 facing toward the escape wheel 120 are designed having a second component height H running parallel to the bearing axis 111 and are aligned parallel with one another. The first component height h of the escape wheel 120 or the escape wheel teeth 122 is less than the second component height H of the anchor 110 or the anchor pallets 112. For example, the escape wheel 120 can have a first component height h in the range of 100 to 150 μm and the anchor 110 can have a second component height H in the range of 200 to 350 μm.

The respective bearing pins 113, 123 are also shown, by means of which the anchor 110 is pivotably mounted around its bearing axis 111 and the escape wheel 120 is rotatably mounted around its axis of rotation 121. The bearing play and the resulting tiltability of the anchor 110 and the escape wheel 120 are illustrated using the double arrows inserted into the drawing. The bearing play of the bearing pins 113, 123 is preferably at least 5 μm in the radial direction and 50 μm in the axial direction. A bearing play determined in this way results in a tiltability of 0.3° of the anchor 110 in relation to the bearing axis 111 or of the escape wheel 120 in relation to the axis of rotation 121, which leads to a possible height offset of 12 μm between the two components.

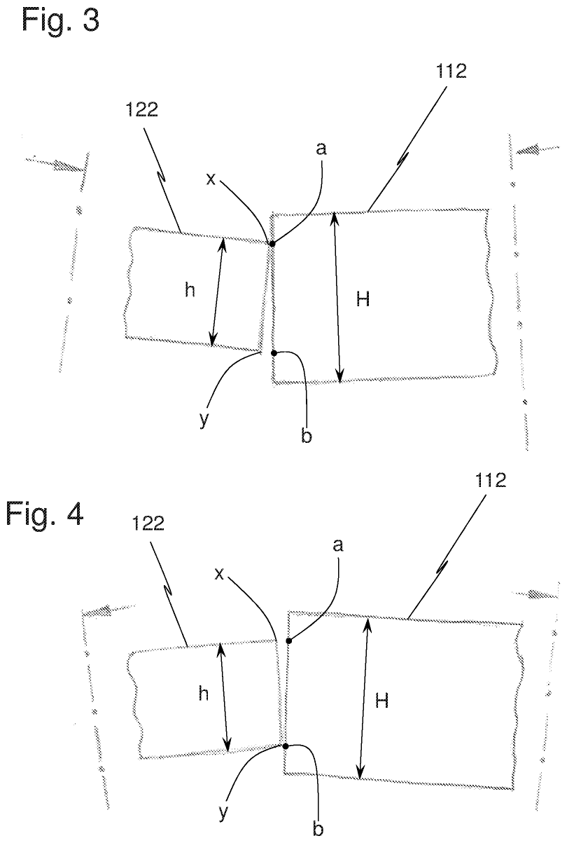

Due to the bearing play, during operation of the anchor escapement 100, depending on its orientation or position, a bevel or inclination of the surfaces facing radially outward of the escape wheel teeth 122 to the surfaces of the anchor pallets 112 facing toward the escape wheel 120 is implemented, which is illustrated in FIGS. 3 and 4. These show a schematic side view of an escape wheel tooth 122 and an anchor pallet 112. The escape wheel tooth 122 has the first component height h, which is less than the second component height H of the anchor pallet 112. By means of the axes shown, the deflection or tilting of the escape wheel tooth 122 and the anchor pallet 112 relative to their axis of rotation 121 or bearing axis 112 is shown (see FIGS. 1 and 2). The angle by which the escape wheel teeth 122 or the anchor pallets 112 is tiltable is preferably 0.3°, particularly preferably 0.4°. Due to the bevel or inclination of the two surfaces relative to one another, and due to the different component heights h, H, the escape wheel tooth 122 slides according to the orientation shown in FIG. 3 with a first, here upper contact edge x on a corresponding and thus defined first contact surface a of the anchor pallet 112 and according to the orientation shown in FIG. 4 with a second, here lower contact edge y on a corresponding and thus defined second contact surface b of the anchor pallet 112. Depending on the orientation of the anchor escapement 100, the escape wheel teeth 122 slide on either the first contact surface a or the second contact surface b of the anchor pallet 112. The first and second contact surfaces a, b are arranged spaced apart from one another along the second component height H of the anchor pallet 112, wherein the spacing is preferably between 12 μm and 100 μm. In the exemplary embodiment shown here, the different contact surfaces a, b are implemented by two contact edges x, y of a single escape wheel tooth 122.

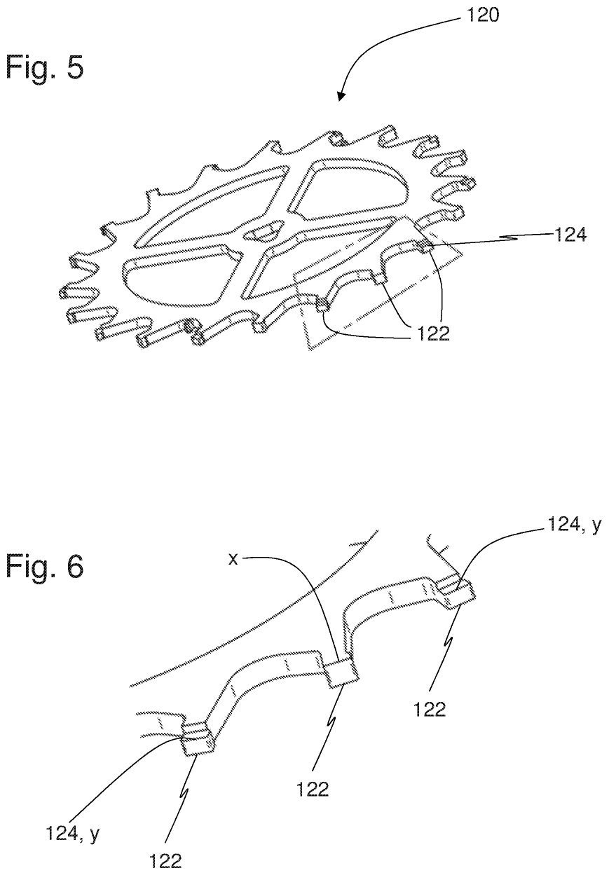

FIG. 5 shows an escape wheel 120 according to a second exemplary embodiment of the anchor escapement 100 according to the invention. The escape wheel 120 is designed here, for example, as a spur gear having escape wheel teeth 122 distributed over its outer circumference and facing radially outwards. The surfaces facing radially outward of the escape wheel teeth 122 are alternately, i.e., every second escape wheel tooth 122, provided with a shoulder 124, as shown in a detailed view by means of FIG. 6. The shoulder 124 is formed at half the component height h of the escape wheel tooth 122 and defines the position of a second contact edge y there. The position of the respective first contact edge x, which is formed on the adjacent escape wheel teeth 122, is defined by the first component height h of the escape wheel teeth 122 itself.

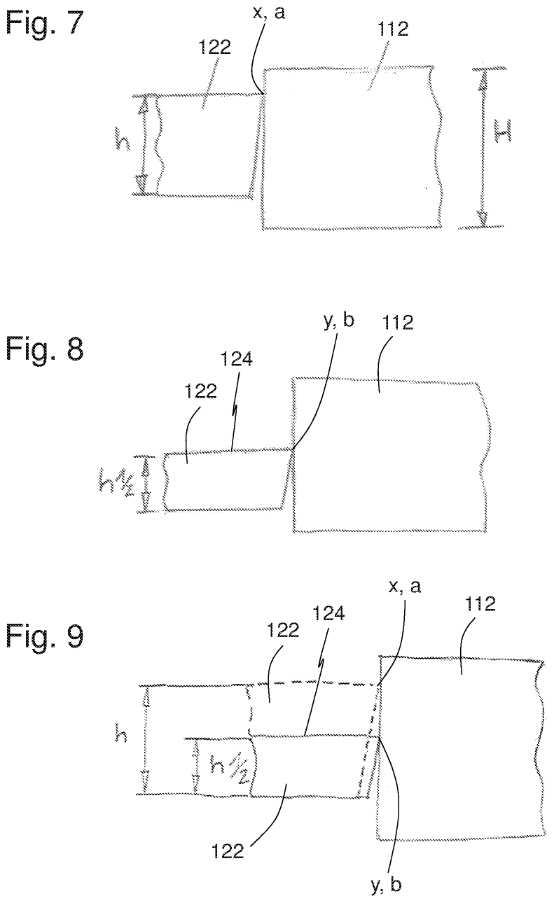

The interaction between the contact edges x, y of two escape wheel teeth 122 and the contact surfaces a, b of an anchor pallet 112 is schematically shown in FIGS. 7 to 9. FIG. 7 shows an escape wheel tooth 122 having a first component height h and an anchor pallet 112 having a second component height H. In order to clearly define a first contact edge x, here on the upper edge of the escape wheel tooth 122, the surface facing radially outward of the escape wheel tooth 122 is designed having a bevel or a non-verticality, i.e., the angle between the surface and the surface facing radially outward is not exactly 90°, but deviates from the right angle, preferably by 0.1° to 3.0°. Due to the bevel or non-verticality and the fact that the first component height h of the escape wheel tooth 122 is less than the second component height H of the anchor pallet 112, the escape wheel tooth 122 always slides with the first contact edge x on the first contact surface a of the anchor pallet 112, in this case independently of the orientation of the anchor escapement 100.

To define a second contact surface b, which is arranged at spaced apart from the first contact surface a with respect to the second component height H, for example, every second escape wheel tooth 122 (optionally every third or fourth, etc.) is designed having a shoulder 124, as schematically shown in FIG. 8. Furthermore, the surface facing radially outward of the escape wheel tooth 122 is again designed having a non-verticality in a range of 0.1° to 3.0°, by which the position of the second contact edge y, here for example at half the component height h of the escape wheel tooth 122, is defined. The escape wheel tooth 122 shown in FIG. 8 therefore always slides with the second contact edge y on the second contact surface b of the anchor pallet 112, independently of the orientation of the anchor escapement 100.

As schematically shown in FIG. 9, when the anchor escapement 100 is in operation, the escape wheel teeth 122 interact sequentially in the direction of rotation with the anchor pallet 122, wherein the first contact edge x of each first escape wheel tooth 122 and the second contact edge y of each second escape wheel tooth 122 alternately slide on the corresponding first contact surface a or the second contact surface b of the anchor pallet 112 in the example shown here. Unlike the first exemplary embodiment (FIGS. 2 to 4), in the second exemplary embodiment of an escape wheel escapement 100 according to the invention shown here, the contact edges x, y sliding on different contact surfaces a, b of one, i.e., the same anchor pallet 112, are formed on different, successive escape wheel teeth 122. Of course, further escape wheel teeth 122 can also be provided with a respective shoulder 124 to define further, for example a third or a fourth, contact edge, which accordingly increases the number of different contact surfaces of the anchor pallet 112.

### LIST OF REFERENCE SIGNS

100 anchor escapement
110 anchor
111 bearing axis
112 anchor palette
113 bearing pin of the anchor
120 escape wheel
121 axis of rotation
122 escape wheel tooth
123 bearing pin of the escape wheel
124 shoulder
a first contact surface
b second contact surface
h first component height (escape wheel teeth)
H second component height (escape wheel pallets)
x first contact edge
y second contact edge

1. An anchor escapement (100) for a mechanical clockwork having an anchor pivotable (110) around its bearing axis (111) and an escape wheel (120) rotatable around an axis of rotation (121), wherein the escape wheel (120) has successive escape wheel teeth (122) in the direction of rotation, which extend over a first component height (h) and the anchor (110) has anchor pallets (112) extending over a second component height (H) at its ends facing toward the escape wheel (120), which are arranged to mesh with the escape wheel teeth (122) of the escape wheel (120), so that when the anchor escapement (100) is in operation, the escape wheel teeth slide (122) in succession on the anchor pallets (112),
characterized in that
the escape wheel teeth (122) and the ends of the anchor pallets (112) facing toward the escape wheel (120) are configured such that the escape wheel teeth (122) slide on at least two different contact surfaces (a, b) of an anchor pallet (112) during operation of the anchor escapement (100).

2. The anchor escapement (100) according to claim 1,
characterized in that
the escape wheel teeth (122) slide during operation of the anchor escapement (100) either along a first contact surface (a) or along a second contact surface (b) of the anchor pallets (112).

3. The anchor escapement (100) according to claim 2
characterized in that
the different contact surfaces (a, b) of the anchor pallets (112) are arranged spaced apart from one another at their ends facing toward the escape wheel (120) and along the second component height (H).

4. The anchor escapement (100) according to claim 1,
characterized in that
the escape wheel teeth (112) are each formed having one or more contact edges (x, y), which slide along a respective contact surface (a, b) of the anchor pallets (112) during operation of the anchor escapement (100).

5. The anchor escapement (100) according to claim 4,
characterized in that
the one or more contact edges (x, y) of the escape wheel teeth (112) are formed by a bevel of the surface facing radially outward of an escape wheel tooth (112).

6. The anchor escapement (100) according to claim 5,
characterized in that
the bevel is formed by a non-verticality of the surface facing radially outward of an escape wheel tooth (112), wherein the non-verticality is in a range between 0.1° and 3.0°.

7. The anchor escapement (100) according to claim 4,
characterized in that
each escape wheel tooth (112) is formed having exactly one contact edge (x, y) and the contact edges (x, y) of at least two escape wheel teeth (112) are formed at positions that deviate from one another along the first component height (h).

8. The anchor escapement (100) according to claim 5,
characterized in that
the position of the contact edge (x, y) along the first component height (h) of an escape wheel tooth (112) is defined by a shoulder (124) formed on the surface facing radially outward.

9. The anchor escapement (100) according claim 1,
characterized in that
the anchor (110) and/or the escape wheel (120) are produced from a material containing silicon and/or at least the contact surfaces (a, b) of the anchor pallets (112) and/or the one or more contact edges (x, y) of the escape wheel teeth (122) are provided with a hard material coating, in particular a silicon, carbon or DLC coating.

10. The anchor escapement (100) claim 4,
characterized in that
the surfaces facing radially outward of each escape wheel tooth (112) are formed along the first component height (h) with a first contact edge (x) and a second contact edge (y), wherein a bevel of the surface facing radially outward is implemented by the anchor (110) being designed to be tiltable around its bearing axis (111) and/or the escape wheel (120) being designed to be tiltable around its axis of rotation (121) by at least 0.3°, preferably at least 0.4°.

11. A pocket or wristwatch having an anchor escapement (100) according to claim 1.

12. The anchor escapement (100) according to claim 1 characterized in that the escapement (100) is for a mechanical clockwork for pocket watches and wristwatches.
